(19) United States
(12) Patent Application Publication
(10) Pub. No.: US 2009/0126679 A1
(43) Pub. Date: May 21, 2009

(54) AIR FILTER DUCT COVER

(76) Inventor: Mary Lou Hoffer, So. Glens Falls, NY (US)

Correspondence Address: MICHAEL RIES, 318 PARKER PLACE, OSWEGO, IL, 60543, US

(21) Appl. No.: 12/271,929

(22) Filed: Nov. 17, 2008

Related U.S. Application Data
(60) Provisional application No. 60/988,890, filed on Nov. 19, 2007.

(51) Int. Cl. F02B 77/00

(52) U.S. Cl. 123/198 E

(57) ABSTRACT

Disclosed is a way to increase the air circulation in buildings with furnaces, air conditioners, etc. with ducts that have openings on filter holders for filters. The present invention would stop the air from being drawn in around the filter opening causing more air being drawn from the return vents to increase circulation.

This application claims priority to U S Provisional Application 60/988,890 filed 19 Nov. 2007, the entire disclosure of which is incorporated by reference.

### TECHNICAL FIELD AND BACKGROUND

The present invention relates to air filter duct covers. More specifically the present invention would seal out air around filter holders.

The present invention has two parts. There are two sides open on a duct filter holder where filters can be placed. One part of the present invention would be just a flat piece of metal or plastic with a foam strip to seal around one side of the duct screwed on over the opening. The other part would protrude from the duct with hinges and a catch or latch again there would be a foam seal around the other side of the duct with hinges and a latch or catch to allow replacement of a filter.

In the present invention the two pieces work together by sealing out air that is causing the loss in circulation due to the filter holders on the ducts having openings with no covers. Air duct filter holders with only one opening to replace a filter, the protruding part works alone to seal out air.

The present invention can be made of plastic or metal. Many different seals, hinges or catches can be used. Hinges and catches or catch can be on the protruding part or flat part. The present device can be formed to fit different size filter holders or the cover may be adjustable to fit many different size filter holders.

### BRIEF DESCRIPTION OF THE DRAWINGS

The objects, features, and advantages of the present invention will be apparent from the following detailed description of the preferred embodiment of the invention with references to the following drawings.

FIG. 1 is a drawing of an air filter duct cover of one embodiment of the present invention.

FIG. 2 is a drawing of an air filter duct cover of one embodiment of the present invention.

FIGS. 3a and 3b are drawings of an air filter duct cover of one embodiment of the present invention.

FIGS. 4a and 4b are drawings of an air filter duct cover of one embodiment of the present inventions.

FIG. 5 is a drawing of an air filter holder of one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

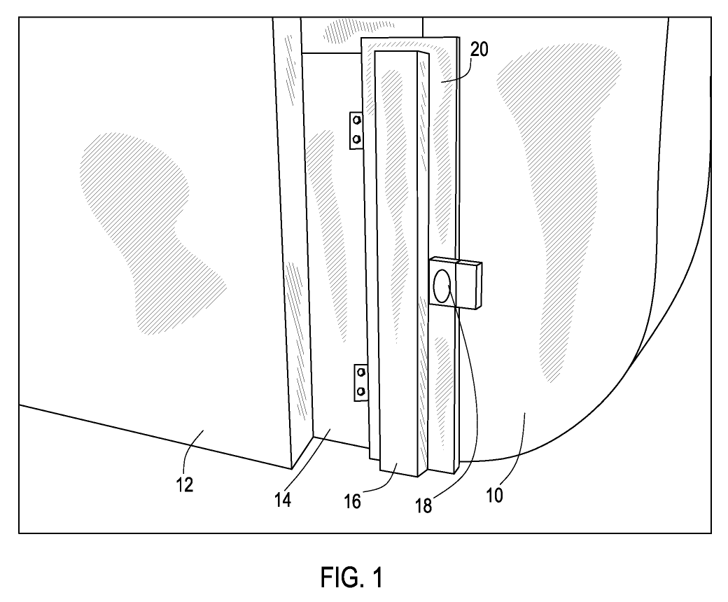

Referring to FIG. 1 as in one embodiment is a return duct 10 and a furnace 12 with a filter holder 14 connecting to the return duct 10 to the furnace 12. The filter holder 14 has an air filter duct cover 16. The air filter duct cover 16 has a catch 18 that secures a protruding piece cover 20 to the return duct 10.

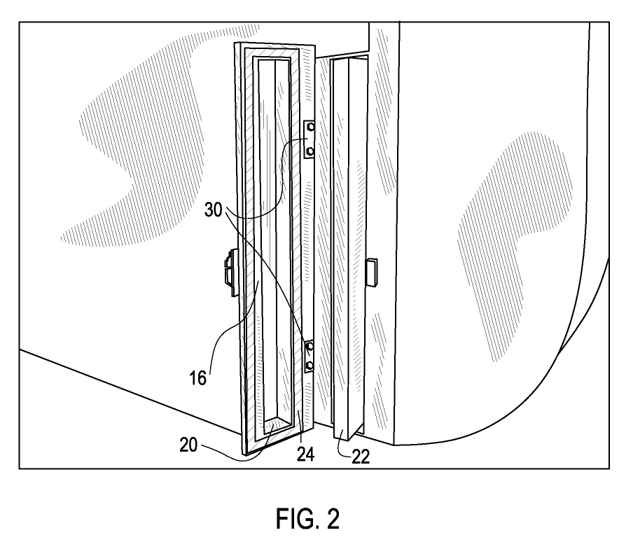

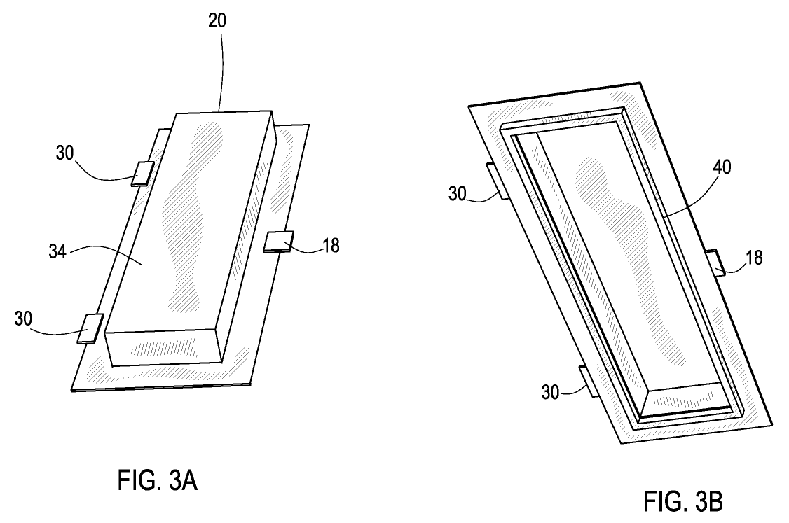

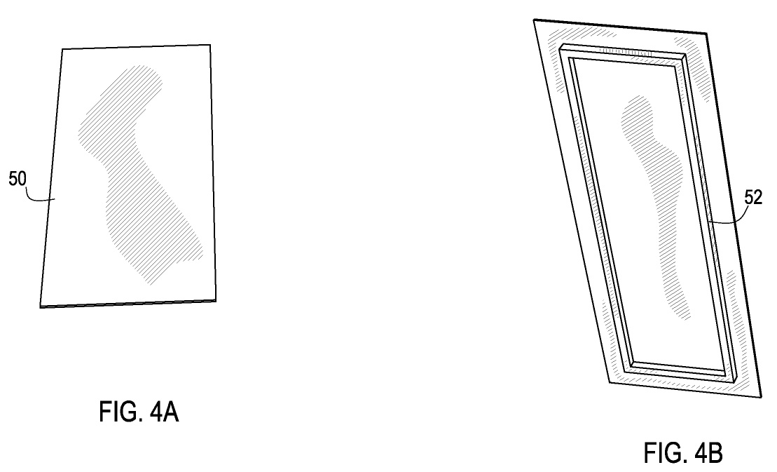

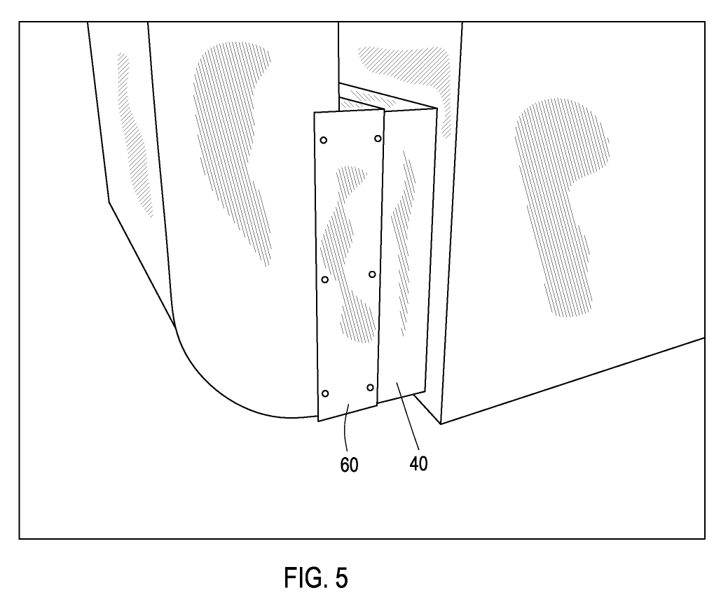

Referring to FIG. 2, as in one embodiment is the air filter duct cover 16 with the protruding piece cover 20 in an open position so you can see a filter 22. Shown is a foam seal 24 on the protruding piece cover 20 and hinges 30. Referring to FIG. 3a, as in one embodiment is a front view of a protruding piece cover 20 with hinges 30 and a protruding piece cover outside 34. In FIG. 3b as in one embodiment is a back view of a protruding piece cover 20. Shown are catch 18, hinges 30 with foam seal 40. Referring to FIGS. 4a and 4b as in one embodiment is a flat piece cover 50. Shown is a foam gasket sealer 52. Referring to FIG. 5 as in one embodiment shown is the filter holder 14 side opposite of the protruding piece cover 20, the opposite side has a fixed cover 60.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An air filter duct cover comprising:
the air filter duct cover has a first part cover and a second part cover, the first part cover has at least one hinge that secures it to a return duct, opposite the at least one hinge of first part cover is a latch, the latch secures the first part cover to a furnace, the latch secures the first part cover closed, the at least one hinge allows the first part cover to open and close, the first part cover goes over a filter holder opening to allow replacement of a filter, the second part cover screws on the return duct and filter holder to cover a second opening, the second opening is on the filter holder opposite the filter holder opening.

2. The air filter duct cover of claim 1 wherein the first part cover is a protruding cover with foam seal on an inside surface.

3. The air filter duct cover of claim 1 wherein the second part cover is a flat cover.

4. An air filter duct cover comprising:
a cover, the cover has at least one latch that secures the cover to a return duct, the cover has at least one hinge to open and close the cover over a filter holder opening to allow a filter to be exchanged.

5. The air filter duct cover of claim 4 wherein the cover is a protruding cover with a foam seal on an inside surface that when secured with the latch seals the filter holder opening.
